(19) United States
(12) Patent Application Publication
(10) Pub. No.: US 2013/0083739 A1
(43) Pub. Date: Apr. 4, 2013

(54) DEVICES FOR RANDOM ACCESS RESPONSE SCHEDULING

(71) Applicant: Shohei Yamada, Camas, WA (US)

(72) Inventor: Shohei Yamada, Camas, WA (US)

(73) Assignee: Sharp Laboratories of America, Inc., Camas, WA (US)

(21) Appl. No.: 13/289,961

(22) Filed: Nov. 4, 2011

Related U.S. Application Data
(60) Provisional application No. 61/543,216, filed on Oct. 4, 2011.

(51) Int. Cl. H04W 74/08; H04W 72/04

(52) U.S. Cl. 370/329

(57) ABSTRACT

An evolved Node B (eNB) configured for random access response scheduling is described. The eNB includes a processor and instructions stored in memory that is in electronic communication with the processor. The eNB sends a message to initiate a random access procedure for a secondary cell (SCell). The eNB also receives a physical random access channel (PRACH) preamble. The eNB further sends a radio network temporary identifier (RNTI) for a random access response (RAR) in a physical downlink control channel (PDCCH) in a user equipment (UE) specific search space. The eNB additionally sends the RAR in a physical downlink shared channel (PDSCH).

### RELATED APPLICATIONS

This application is related to and claims priority from U.S. Provisional Patent Application Ser. No. 61/543,216 filed Oct. 4, 2011, for RANDOM ACCESS RESPONSE SCHEDULING, with inventor Shohei Yamada, which is incorporated herein by reference.

### TECHNICAL FIELD

The present disclosure relates generally to communication systems. More specifically, the present disclosure relates to devices for random access response scheduling.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station.

As wireless communication devices have advanced, improvements in communication capacity, speed and/or quality have been sought. However, improvements in communication capacity, speed and/or quality may require increased resources.

For example, wireless communication devices may communicate with one or more devices using multiple channels or cells. However, communicating with one or more devices using multiple channels or cells may pose certain challenges. As illustrated by this discussion, systems and methods that enable or improve communication using multiple channels or cells may be beneficial.

### BRIEF DESCRIPTION OF THE DRAWINGS

FIG. 1 is a diagram illustrating one example of a random access procedure in a primary cell (PCell);

FIG. 2 is a diagram illustrating a common search space overload by using a random access radio network temporary identifier (RA-RNTI) for a physical random access channel (PRACH) of another cell;

FIG. 3 is a block diagram illustrating one configuration of one or more user equipments (UEs) and one or more evolved Node Bs (eNBs) in which systems and methods for random access response scheduling may be implemented;

FIG. 4 is a flow diagram illustrating one configuration of a method for random access response scheduling on an evolved Node B (eNB);

FIG. 5 is a flow diagram illustrating one configuration of a method for random access response scheduling on a user equipment (UE);

FIG. 6 is a block diagram illustrating one example of cross carrier scheduling in accordance with the systems and methods disclosed herein;

FIG. 7 is a block diagram illustrating one example of radio resource control (RRC) connection reconfiguration signaling;

FIG. 8 is a diagram illustrating one example of a physical downlink control channel (PDCCH) for a random access response (RAR) cell radio network temporary identifier (C-RNTI) or a RA-RNTI and a physical downlink shared channel (PDSCH) for RAR in a scheduling cell;

FIG. 9 is a diagram illustrating an example of a physical downlink control channel (PDCCH) for a random access response (RAR) cell radio network temporary identifier (C-RNTI) or a RA-RNTI and a physical downlink shared channel (PDSCH) for RAR in a primary cell (PCell);

FIG. 10 is a diagram illustrating an example of a physical downlink control channel (PDCCH) for a random access response (RAR) cell radio network temporary identifier (C-RNTI) or a RA-RNTI in a scheduling cell and a physical downlink shared channel (PDSCH) for a RAR in a scheduled cell;

FIG. 11 is a diagram illustrating an example of a physical downlink control channel (PDCCH) for a random access response (RAR) cell radio network temporary identifier (C-RNTI) or a RA-RNTI and a physical downlink shared channel (PDSCH) for a RAR in any cell;

FIG. 12 is a diagram illustrating one example of a physical downlink control channel (PDCCH) downlink control information format for a random access response (RAR) cell radio network temporary identifier (C-RNTI) with a carrier indicator field (CIF);

FIG. 13 is a diagram illustrating an example of a physical downlink control channel (PDCCH) downlink control information format for a random access response (RAR) cell radio network temporary identifier (C-RNTI) without a carrier indicator field (CIF);

FIG. 14 is a diagram illustrating an example of a physical downlink control channel (PDCCH) downlink control information format for a random access response (RAR) cell radio network temporary identifier (C-RNTI) with a carrier indicator field (CIF) and a control format indicator (CFI);

FIG. 15 illustrates various components that may be utilized in a user equipment (UE); and

FIG. 16 illustrates various components that may be utilized in an evolved Node B (eNB).

### DETAILED DESCRIPTION

An evolved Node B (eNB) configured for random access response scheduling is described. The eNB includes a processor and instructions stored in memory that is in electronic communication with the processor. The eNB sends a message to initiate a random access procedure for a secondary cell (SCell). The eNB also receives a physical random access channel (PRACH) preamble. The eNB further sends a radio network temporary identifier (RNTI) for a random access response (RAR) in a physical downlink control channel (PDCCH) in a user equipment (UE) specific search space. The eNB additionally sends the RAR in a physical downlink shared channel (PDSCH). A cell in which the PRACH preamble is received may be different from a cell in which the RNTI for the RAR is sent. The UE specific search space may be calculated based on a cell radio network temporary identifier (C-RNTI).

Cyclic redundancy check (CRC) parity bits of the PDCCH may be scrambled by the RNTI. The PDCCH with the RNTI for the RAR may use a DCI Format 1A.

Downlink control information (DCI) for the PDCCH with the RNTI for the RAR may include a carrier indicator. The DCI for the PDCCH with the RNTI for the RAR may include a control format indicator.

A method for random access response scheduling on an evolved Node B (eNB) is also described. The method includes sending a message to initiate a random access procedure for a secondary cell (SCell). The method also includes receiving a physical random access channel (PRACH) preamble. The method further includes sending a radio network temporary identifier (RNTI) for a random access response (RAR) in a physical downlink control channel (PDCCH) in a user equipment (UE) specific search space. The method additionally includes sending the RAR in a physical downlink shared channel (PDSCH).

A User Equipment (UE) configured for random access response scheduling is also described. The UE includes a processor and instructions stored in memory that is in electronic communication with the processor. The UE receives a message to initiate a random access procedure for a secondary cell (SCell). The UE also sends a physical random access channel (PRACH) preamble. The UE further receives a radio network temporary identifier (RNTI) for a random access response (RAR) in a physical downlink control channel (PDCCH) in a user equipment (UE) specific search space. The UE additionally receives the RAR in a physical downlink shared channel (PDSCH). A cell in which the PRACH preamble is sent may be different from a cell in which the RNTI for the RAR is received. Cyclic redundancy check (CRC) parity bits of the PDCCH may be scrambled by the RNTI. The UE specific search space may be calculated based on a cell radio network temporary identifier (C-RNTI). The UE may not perform a hybrid automatic repeat request (HARQ) process for the RAR.

Downlink control information (DCI) for the PDCCH with the RNTI for the RAR may include a carrier indicator. The DCI for the PDCCH with the RNTI for the RAR may include a control format indicator. The PDCCH with the RNTI for the RAR may use a DCI Format 1A.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP specifications (e.g., LTE, LTE-Advanced (LTE-A), Release-8, Release-10, Release-11, Global System for Mobile Communications (GSM), etc.). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a user equipment (UE), an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, mobile devices, gaming systems, computers, etc. In 3GPP specifications, a wireless communication device is typically referred to as a user equipment (UE). However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a Node B, an evolved or enhanced Node B (eNB), a home enhanced or evolved Node B (HeNB) or some other similar terminology. As the scope of the disclosure should not be limited to 3GPP standards, the terms “base station,” “Node B,” “eNB” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands to be used for communication between a Node B (e.g., eNB) and a UE. “Configured cells” are those cells of which the UE is aware and is allowed by a Node B (e.g., eNB) to transmit or receive information. “Configured cell(s)” may be serving cell(s). The UE may receive system information and perform the required measurements on all configured cells. “Activated cells” are those configured cells on which the UE is transmitting or receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics. For instance, a spatial characteristic of a cell may be described in terms of size. As used herein, the phrase “any cell” and variations thereof may mean any cell that a UE may use to transmit information to and/or receive information from an eNB and/or any cell that an eNB may use to may use to transmit information to and/or receive information from a UE.

If carrier aggregation is configured, a user equipment (UE) may have (e.g., communicate using) multiple serving cells: a primary cell (PCell) and one or more secondary cells (SCell). From a network perspective, the same serving cell may be used as the primary cell (PCell) by one user equipment (UE) and used as a secondary cell (SCell) by another user equipment (UE). A primary cell (PCell) that is operating according to Release-8 or Release-9 may be equivalent to the Release-8 or Release-9 serving cell. When operating according to Release-10, there may be one or more secondary cells (SCell) in addition to the primary cell (PCell) if carrier aggregation is configured.

When carrier aggregation is configured, a user equipment (UE) may have only one Radio Resource Control (RRC) connection with the network. At the RRC connection establishment, re-establishment and/or handover, one serving cell (e.g., the primary cell (PCell)) may provide the non-access stratum (NAS) mobility information (e.g., Tracking Area Identity (TAI)) and the security input.

In the downlink, the carrier corresponding to the primary cell (PCell) is the downlink primary component carrier (DL PCC). In the uplink, the carrier corresponding to the primary cell (PCell) is the uplink primary component carrier (UL PCC). Depending on the capabilities of the user equipment (UE), one or more secondary component carriers (SCC) or secondary cells (SCell) may be configured to form a set of serving cells with the primary cell (PCell). In the downlink, the carrier corresponding to the secondary cell (SCell) is the downlink secondary component carrier (DL SCC). In the uplink, the carrier corresponding to the secondary cell (SCell) is the uplink secondary component carrier (UL SCC). The number of downlink component carriers may be different from the number of uplink component carriers because multiple cells may share one uplink component carrier.

Some configurations of the systems and methods disclosed herein describe random access response scheduling for one or more SCells for LTE-A. For example, the systems and methods disclosed herein relate to how a user equipment (UE) behaves in a case that the UE is configured for carrier aggregation with multiple timing alignment groups or multiple random access channels. For convenience, several abbreviations are used herein. Some of these abbreviations are given as follows: primary cell (PCell), secondary cell (SCell), random access response (RAR), random access (RA), physical random access channel (PRACH), user equipment or mobile station (UE), evolved eNB or base station (eNB), message (Msg), hybrid automatic repeat request (HARQ), radio resource control (RRC), radio network temporary identifier (RNTI), cell RNTI (C-RNTI), Random Access RNTI (RA-RNTI), Random Access Response C-RNTI (RAR C-RNTI), carrier indicator field (CIF) and physical downlink control channel (PDCCH).

Various configurations are described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

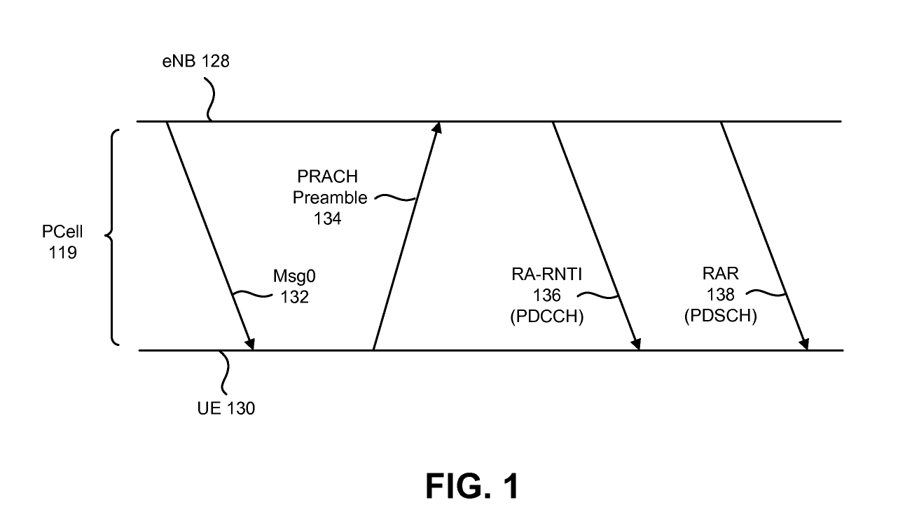

FIG. 1 is a diagram illustrating one example of a random access procedure in a primary cell (PCell) 119. In this example, an eNB 128 sends a Msg0 132 to a UE 130. The UE 130 sends a PRACH preamble 134 to the eNB 128. The eNB 128 then sends a RA-RNTI 136 on a PDCCH and a RAR 138 on a PDSCH.

In Release-11, random access in a secondary cell (SCell) is introduced. Apart from a PCell 119, an SCell can be cross carrier scheduled. To support a RA procedure for the SCell and cross carrier scheduling, a random access response (RAR) may need to be cross carrier scheduled, which is not supported in the PCell 119.

There are several solutions to this issue that have been proposed. One solution is that a RAR is extended to also (explicitly) indicate the cell index where a PRACH preamble (e.g., Msg1) was sent. Another solution is that the RA-RNTI range is extended and used to implicitly indicate the carrier where a PRACH preamble (e.g., Msg1) was sent. Another is to use C-RNTI to address a RAR, where a new MAC control element is defined for the RAR.

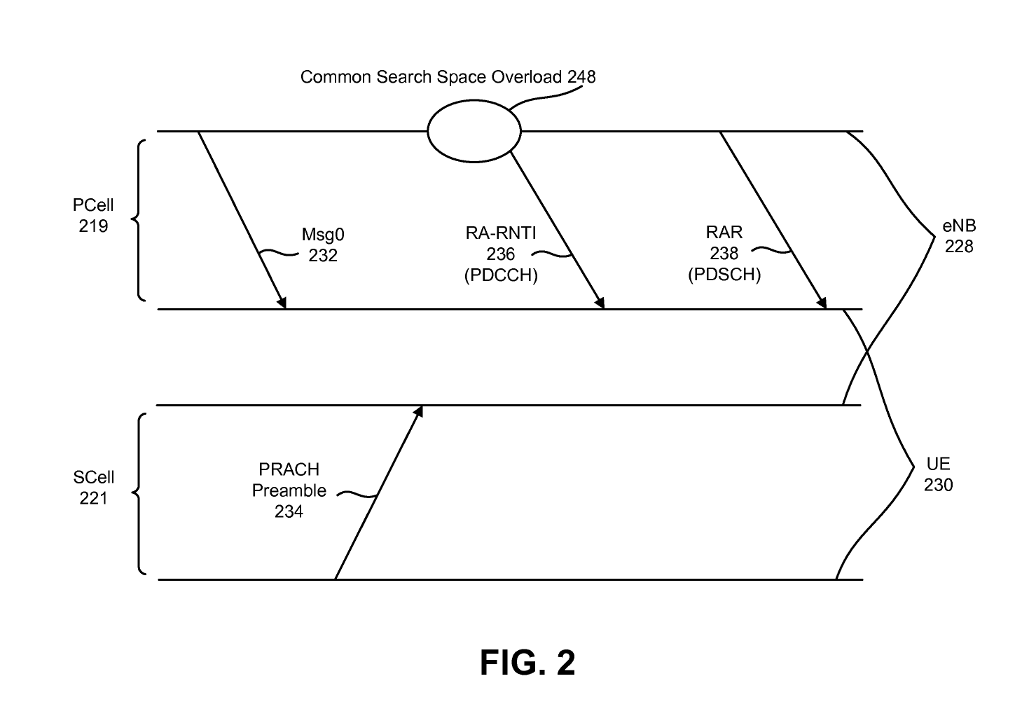

FIG. 2 is a diagram illustrating a common search space overload 248 by using a random access radio network temporary identifier (RA-RNTI) 236 for a physical random access channel (PRACH) of another cell. In particular, FIG. 2 illustrates a Msg0 232 sent in a PCell 219 from an eNB 228 to a UE 230. The UE 230 may respond by sending a PRACH preamble 234 in an SCell 221. The eNB 228 may send an RA-RNTI 236 on a PDCCH and an RAR 238 on a PDSCH to the UE 230. None of the proposed solutions can avoid the complexity or impact such as a common search space overload 248 or HARQ processing complexity.

Several aspects of the systems and methods disclosed herein may include one or more of the following. A UE may be allocated a new C-RNTI, which may be referred to herein as a random access response cell radio network temporary identifier or “RAR C-RNTI.” The RAR C-RNTI may be used to schedule a RAR for a PRACH preamble transmission on an SCell. Cyclic redundancy check (CRC) parity bits of a PDCCH may be scrambled by the RAR C-RNTI. The PDCCH with the RAR C-RNTI may schedule the PDSCH for RAR and is transmitted in a UE specific search space that is calculated by a C-RNTI (e.g., normal C-RNTI). The UE may not perform a HARQ process for the RAR.

The user equipment (UE) may monitor a set of physical downlink control channel (PDCCH) candidates on one or more activated serving cells. In one configuration, the user equipment (UE) may monitor a set of physical downlink control channel (PDCCH) candidates on one or more activated serving cells as configured by higher layer signaling for control information. More than one serving cell may be configured by the radio resource control (RRC) and a serving cell may be activated or deactivated by the medium access control (MAC) layer. The set of physical downlink control channel (PDCCH) candidates to monitor may be defined in terms of search spaces. The primary cell (PCell) may have both a common search space and a UE specific search space. A secondary cell (SCell) may have a UE specific search space. The UE specific search space is defined by the Cell Radio Network Temporary Identifier (C-RNTI ((UEID)) and is prepared for each serving cell.

In cross carrier scheduling, a scheduling cell has a UE specific search space for its scheduling cell and a UE specific search space for a scheduled cell. Cross carrier scheduling may happen if a scheduling cell is different from a scheduled cell. However, the systems and methods described herein can also be applied in a non cross carrier scheduling context. For example, a scheduling cell and a scheduled cell may be the same cell in some configurations. The scheduling cell is identified by whether a carrier indicator field (CIF) may be present in PDCCH DCI formats which may be used on the cell. Scheduling cells may be a PCell and/or one or more SCells. Scheduled cells may be one or more SCells. A carrier indicator field may be attached to PDCCH DCI formats located in a UE specific search space but not in a common search space. The carrier indicator is transmitted in the carrier indicator field, which indicates a serving cell index for a scheduled serving cell.

Several physical downlink control channel (PDCCH) downlink control information (DCI) formats may be used in accordance with the systems and methods disclosed herein. The user equipment (UE) may detect a physical downlink control channel (PDCCH) of a serving cell intended for the user equipment (UE) in a subframe (of a radio frame, for example). In one configuration, the physical downlink control channel (PDCCH) detected may be a physical downlink control channel (PDCCH) with a DCI Format of 1, 1A, 1B, 1C, 1D, 2, 2A, 2B or 2C. The user equipment (UE) may decode the corresponding physical downlink shared channel (PDSCH) in the same subframe. The DCI format 1A may be always monitored by a UE with any transmission mode. The other DCI formats to be monitored may depend on a transmission mode configured for the UE.

Different kinds of information or data may be transmitted (and received) in the common search space. For example, a PDCCH to schedule system information or paging information, random access related information or normal UE data may be transmitted in the common search space. The physical layer of a UE may be configured by higher layers with a RNTI. The UE may decode the PDCCH with a cyclic redundancy check (CRC) scrambled by the RNTI. Downlink control information that is conveyed by PDCCH may have attached CRC. The CRC may be scrambled by the RNTI, where both are 16 bits, for example. For instance, the CRC may be XORed with the RNTI. Some examples of the radio network temporary identifier (RNTI) include system information RNTI (SI-RNTI), paging RNTI (P-RNTI), cell RNTI (C-RNTI), random access RNTI (RA-RNTI), semi-persistent scheduling C RNTI (SPS C-RNTI), temporary C-RNTI, transmit power control physical uplink control channel RNTI (TPC-PUCCH-RNTI) and transmit power control physical uplink shared channel RNTI (TPC-PUSCH-RNTI). In some cases, the UE may monitor the RNTI (if it is configured to be monitored, for example). The RA-RNTI and the temporary C-RNTI may be used for PDCCH random access related scheduling information. The C-RNTI, temporary C-RNTI or RAR C-RNTI is a unique UE identity, where “C” reflects that this UE identity is unique for the UE in this cell. SI-RNTI, RA-RNTI, P-RNTI, TPC-PUCCH-RNTI, TPC-PUSCH-RNTI is also a unique ID, but multiple UEs may share the same value.

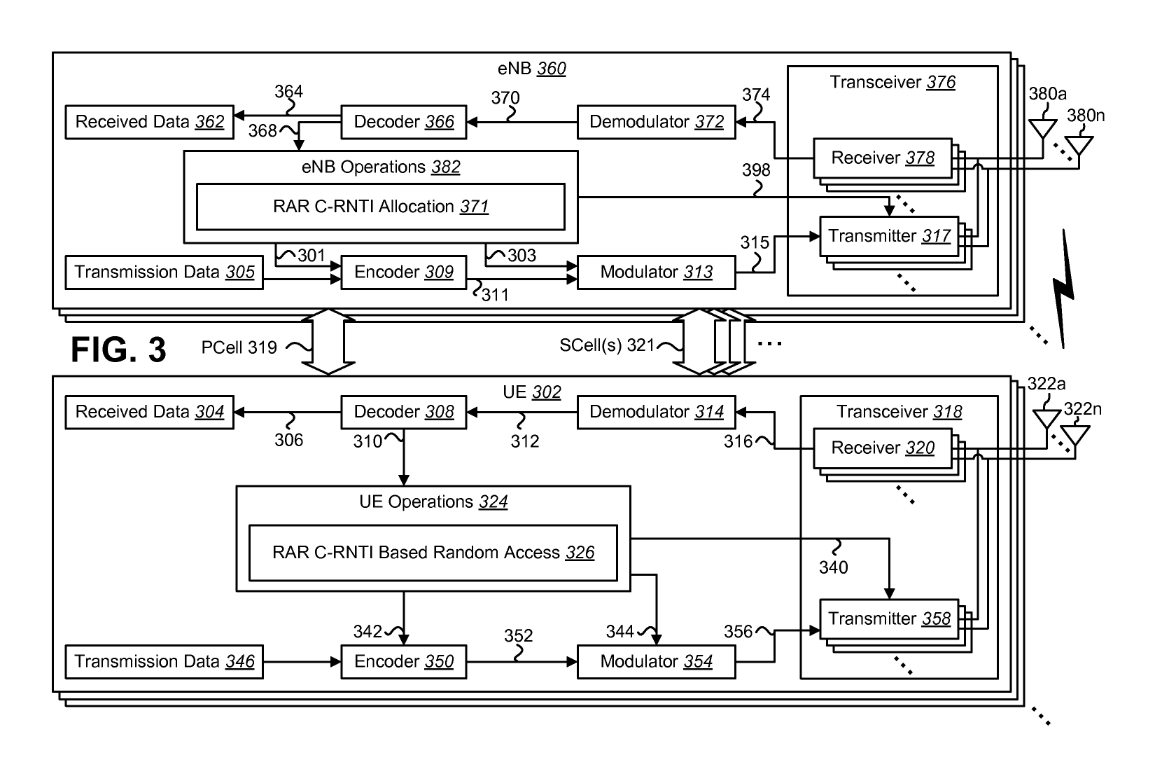

FIG. 3 is a block diagram illustrating one configuration of one or more user equipments (UEs) 302 and one or more evolved Node Bs (eNBs) 360 in which systems and methods for random access response scheduling may be implemented. A UE 302 communicates with one or more evolved Node Bs (eNBs) 360 using one or more antennas 322a-n. For example, a UE 302 transmits electromagnetic signals to an eNB 360 and receives electromagnetic signals from the eNB 360 using the one or more antennas 322a-n. The eNB 360 communicates with the UE 302 using one or more antennas 380a-n. It should be noted that the eNB 360 may be a Node B, home evolved Node B (HeNB) or other kind of base station in some configurations.

The UE 302 and the eNB 360 may use one or more cells (e.g., channels, carriers, carrier components, etc.) 319, 321 to communicate with each other. For example, the UE 302 and eNB 360 may use the cells 319, 321 to carry one or more channels (e.g., Physical Uplink Control Channel (PUCCH), Physical Uplink Shared Channel (PUSCH), physical downlink control channel (PDCCH), etc.) A PUCCH is one example of a control channel pursuant to 3GPP specifications. Other kinds of channels may be used.

In accordance with the systems and methods disclosed herein, multiple kinds of cells 319, 321 and/or multiple groups of cells 319, 321 may be used for communication. As used herein, the term “group” may denote a group of one or more entities. A primary cell (PCell) 319 may be a primary cell in accordance with 3GPP specifications. A secondary cell (SCell) 321 may be a secondary cell in accordance with 3GPP specifications.

In one case, a single eNB 360 may communicate with the UE 302 using a PCell 319 and one or more SCells 321. In another case, one eNB 360 may communicate with the UE 302 using the PCell 319 (and optionally one or more SCells 321, for example), while another eNB 360 may communicate with the UE 302 using one or more SCells 321.

The UE 302 may include one or more transceivers 318, one or more demodulators 314, one or more decoders 308, one or more encoders 350, one or more modulators 354 and a UE operations module 324. For example, one or more reception and/or transmission paths may be used in the UE 302. For convenience, only a single transceiver 318, decoder 308, demodulator 314, encoder 350 and modulator 354 are illustrated, though multiple parallel elements (e.g., transceivers 318, decoders 308, demodulators 314, encoders 350 and modulators 354) may be used depending on the configuration.

The transceiver 318 may include one or more receivers 320 and one or more transmitters 358. The one or more receivers 320 may receive signals from the eNB 360 using one or more antennas 322a-n. For example, the receiver 320 may receive and downconvert signals to produce one or more received signals 316. The one or more received signals 316 may be provided to a demodulator 314. The one or more transmitters 358 may transmit signals to the eNB 360 using one or more antennas 322a-n. For example, the one or more transmitters 358 may upconvert and transmit one or more modulated signals 356.

The demodulator 314 may demodulate the one or more received signals 316 to produce one or more demodulated signals 312. The one or more demodulated signals 312 may be provided to the decoder 308. The UE 302 may use the decoder 308 to decode signals. The decoder 308 may produce one or more decoded signals 306, 310. For example, a first UE-decoded signal 306 may comprise received payload data 304. A second UE-decoded signal 310 may comprise overhead data and/or control data. For example, the second UE-decoded signal 310 may provide data that may be used by the UE operations module 324 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 324 may be implemented in hardware, software or a combination of both.

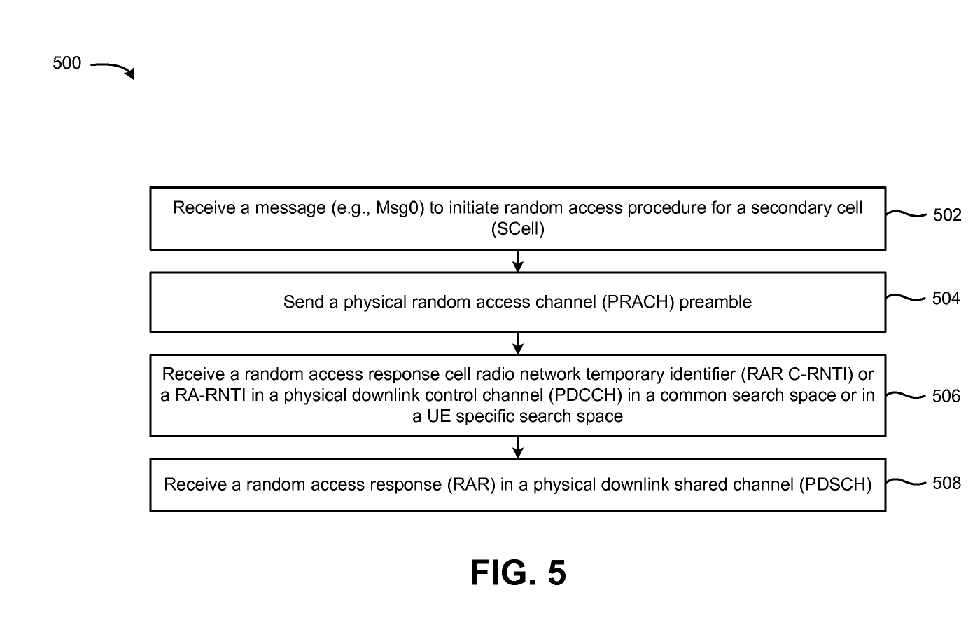

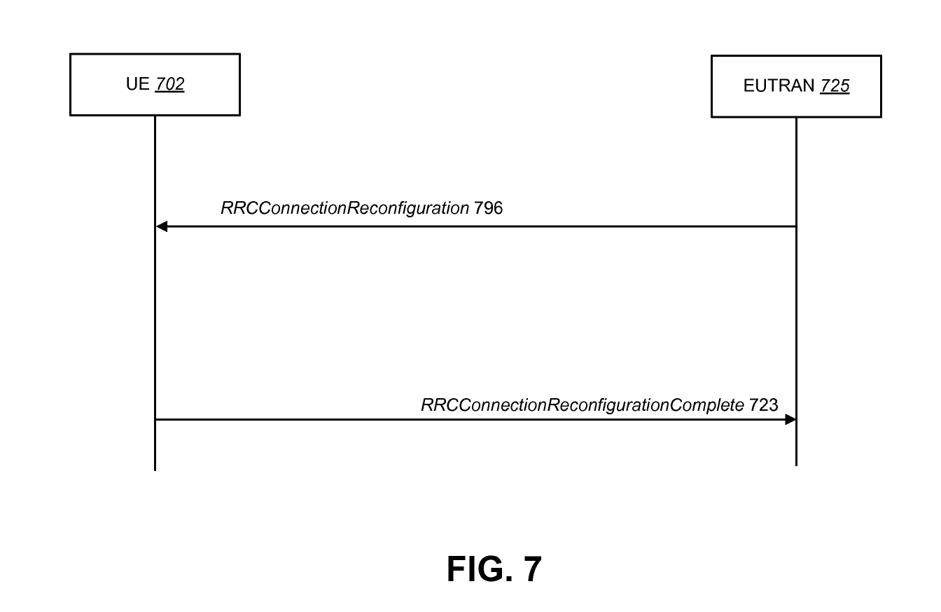

In general, the UE operations module 324 may enable the UE 302 to communicate with one or more eNBs 360. The UE operations module 324 may include a random access response cell radio network temporary identifier (RAR C-RNTI) based random access module 326. The RAR C-RNTI based random access module 326 may enable the UE 302 to communicate using random access procedures based on a RAR C-RNTI or a RA-RNTI as described herein. Greater detail is given below concerning such random access procedures using a RAR C-RNTI or a RA-RNTI. For example, the UE 302 may use the UE operations module 324 to perform the method 500 described in connection with FIG. 5 below. In some configurations, a RAR C-RNTI assignment may be done in accordance with an RRC connection reconfiguration procedure as described below in connection with FIG. 7.

The UE operations module 324 may provide information 342 to the encoder 350. This information 342 may include instructions for the encoder 350 and/or data to be encoded. For example, the information 342 may include control data.

The encoder 350 may encode transmission data 346 and/or other information 342 provided by the UE operations module 324. For example, encoding the data 346 and/or other information 342 may involve error detection and/or correction coding, mapping data to space, time and/or frequency resources for transmission, etc. The encoder 350 may provide encoded data 352 to the modulator 354.

The UE operations module 324 may provide information 344 to the modulator 354. This information 344 may include instructions for the modulator 354. For example, the UE operations module 324 may instruct the modulator 354 regarding a modulation type (e.g., constellation mapping). The modulator 354 may modulate the encoded data 352 to provide one or more modulated signals 356 to the one or more transmitters 358.

The UE operations module 324 may provide information 340 to the one or more transmitters 358. This information 340 may include instructions for the one or more transmitters 358. The one or more transmitters 358 may upconvert and transmit the modulated signal(s) 356 to one or more eNBs 360.

Each of the one or more eNBs 360 may include one or more transceivers 376, one or more demodulators 372, one or more decoders 366, one or more encoders 309, one or more modulators 313 and an eNB operations module 382. For example, one or more reception and/or transmission paths may be used in an eNB 360. For convenience, only a single transceiver 376, decoder 366, demodulator 372, encoder 309 and modulator 313 are illustrated, though multiple parallel elements (e.g., transceivers 376, decoders 366, demodulators 372, encoders 309 and modulators 313) may be used depending on the configuration.

The transceiver 376 may include one or more receivers 378 and one or more transmitters 317. The one or more receivers 378 may receive signals from the UE 302 using one or more antennas 380a-n. For example, the receiver 378 may receive and downconvert signals to produce one or more received signals 374. The one or more received signals 374 may be provided to a demodulator 372. The one or more transmitters 317 may transmit signals to the UE 302 using one or more antennas 380a-n. For example, the one or more transmitters 317 may upconvert and transmit one or more modulated signals 315.

The demodulator 372 may demodulate the one or more received signals 374 to produce one or more demodulated signals 370. The one or more demodulated signals 370 may be provided to the decoder 366. The eNB 360 may use the decoder 366 to decode signals. The decoder 366 may produce one or more decoded signals 364, 368. For example, a first eNB-decoded signal 364 may comprise received payload data 362. A second eNB-decoded signal 368 may comprise overhead data and/or control data. For example, the second eNB-decoded signal 368 may provide data that may be used by the eNB operations module 382 to perform one or more operations.

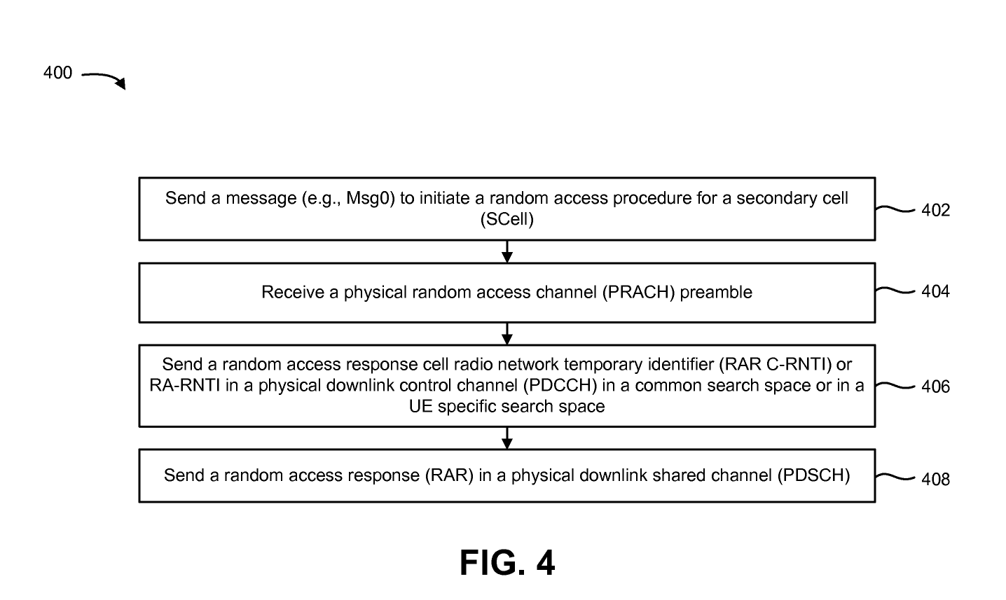

In general, the eNB operations module 382 may enable the eNB 360 to communicate with a UE 302 that is using one or more cells 319, 321. The eNB operations module 382 may include a random access response cell radio network temporary identifier (RAR C-RNTI) allocation module 371. The RAR C-RNTI allocation module 371 allocates a RAR C-RNTI or a RA-RNTI for a random access procedure as described herein. Greater detail on the use a RAR C-RNTI or a RA-RNTI for random access procedures is given below. For example, the eNB 360 may use the eNB operations module 382 to perform the method 400 described in connection with FIG. 4 below.

The eNB operations module 382 may provide information 301 to the encoder 309. This information 301 may include instructions for the encoder 309 and/or data to be encoded. For example, the eNB operations module 382 may instruct the encoder 309 regarding an encoding rate. Additionally or alternatively, the information 301 may include data to be encoded.

The encoder 309 may encode transmission data 305 and/or other information 301 provided by the eNB operations module 382. For example, encoding the data 305 and/or other information 301 may involve error detection and/or correction coding, mapping data to space, time and/or frequency resources for transmission, etc. The encoder 309 may provide encoded data 311 to the modulator 313. The transmission data 305 may include network data to be relayed to the UE 302.

The eNB operations module 382 may provide information 303 to the modulator 313. This information 303 may include instructions for the modulator 313. For example, the eNB operations module 382 may instruct the modulator 313 regarding a modulation type (e.g., constellation mapping). The modulator 313 may modulate the encoded data 311 to provide one or more modulated signals 315 to the one or more transmitters 317.

The eNB operations module 382 may provide information 398 to the one or more transmitters 317. This information 398 may include instructions for the one or more transmitters 317. For example, the eNB operations module 382 may instruct the one or more transmitters 317 to transmit using one or more cells 319, 321. The one or more transmitters 317 may upconvert and transmit the modulated signal(s) 315 to the UE 302.

FIG. 4 is a flow diagram illustrating one configuration of a method 400 for random access response scheduling on an evolved Node B (eNB). The eNB described in connection with FIG. 4 may be one example of the eNB 360 described in connection with FIG. 3. The eNB may send 402 a message (e.g., Msg0) to initiate a random access procedure (e.g., a non-contention based random access procedure, though a contention based random access procedure may additionally or alternatively be initiated) for a secondary cell (SCell). The message may be sent on a first cell. Examples of the first cell include a scheduling cell and/or a primary cell (PCell) (e.g., PCell 319).

The eNB may receive 404 a physical random access channel (PRACH) preamble. For example, the eNB may receive 404 the PRACH preamble on a second cell. Examples of the second cell include a scheduled cell and/or a secondary cell (SCell) (e.g., SCell 321).

The eNB may send 406 a random access response cell radio network temporary identifier (RAR C-RNTI) or RA-RNTI in a physical downlink control channel (PDCCH) in a common search space or in a UE specific search space. For instance, the eNB may send 406 a RNTI (e.g., RAR C-RNTI or RA-RNTI) for a RAR in a PDCCH in a UE specific search space. Depending on the configuration, the RAR C-RNTI or RA-RNTI in the PDCCH may be sent on a scheduling cell, a PCell or any cell. The RAR C-RNTI or RA-RNTI may be used to schedule a RAR (in a PDSCH, for example) based on the PRACH preamble received 404.

The eNB may send 408 a random access response (RAR) in a physical downlink shared channel (PDSCH). Depending on the configuration, the eNB may send the RAR in the PDSCH on a scheduling cell, a scheduled cell, a PCell or any cell.

It should be noted that the eNB may also be able to perform a random access procedure on a PCell, which is the same procedure with non carrier aggregation case. For example, the eNB may send 402 a message (e.g., Msg0) to initiate a random access procedure on a PCell. The message may be sent on the PCell. The eNB may receive 404 a physical random access channel (PRACH) preamble on the PCell. The eNB may send 406 a random access radio network temporary identifier (RA-RNTI) in a physical downlink control channel (PDCCH) in a common search space on the PCell. The RA-RNTI may be used to schedule a RAR (in a PDSCH, for example) based on the PRACH preamble. The eNB may send 408 a random access response (RAR) in a physical downlink shared channel (PDSCH) on the PCell.

FIG. 5 is a flow diagram illustrating one configuration of a method 500 for random access response scheduling on a user equipment (UE). The UE described in connection with FIG. 5 may be one example of the UE 302 described in connection with FIG. 3. The UE may receive 502 a message (e.g., Msg0) to initiate a random access procedure (e.g., a non-contention based random access procedure, though a contention based random access procedure may additionally or alternatively be initiated) for a secondary cell (SCell). The message may be received on a first cell. Examples of the first cell include a scheduling cell and/or a primary cell (PCell) (e.g., PCell 319).

The UE may send 504 a physical random access channel (PRACH) preamble. For example, the UE may send the PRACH preamble on a second cell. Examples of the second cell include a scheduled cell and/or a secondary cell (SCell) (e.g., SCell 321).

The UE may receive 506 a random access response cell radio network temporary identifier (RAR C-RNTI) or a RA-RNTI in a physical downlink control channel (PDCCH) in a common search space or in a UE specific search space. For instance, the UE may receive 506 a RNTI (e.g., RAR C-RNTI or RA-RNTI) for a RAR in a PDCCH in a UE specific search space. Depending on the configuration, the RAR C-RNTI or RA-RNTI in the PDCCH may be received 506 on a scheduling cell, a PCell or any cell. The RAR C-RNTI or RA-RNTI may be used to schedule a RAR (in a PDSCH, for example) based on the PRACH preamble sent 504.

The UE may receive 508 a random access response (RAR) in a physical downlink shared channel (PDSCH). Depending on the configuration, the UE may receive 508 the RAR in the PDSCH on a scheduling cell, a scheduled cell, a PCell or any cell.

The UE may also be able to perform a random access procedure on a PCell. For example, the UE may receive 502 a message (e.g., Msg0) to initiate a random access procedure on a PCell. The message may be received on the PCell. The UE may send 504 a physical random access channel (PRACH) preamble on the PCell. The UE may receive 506 a RA-RNTI in a physical downlink control channel (PDCCH) in a common search space on the PCell. The RA-RNTI may be used to schedule a RAR (in a PDSCH, for example) based on the PRACH preamble. The UE may receive 508 a random access response (RAR) in a physical downlink shared channel (PDSCH) on the PCell.

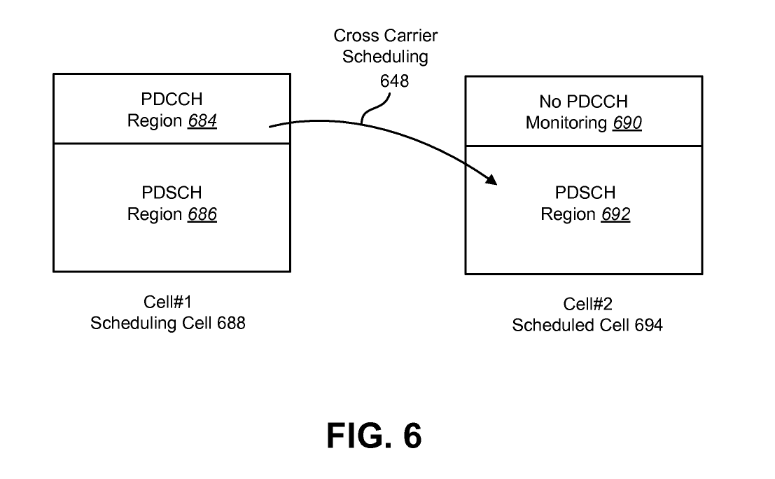

FIG. 6 is a block diagram illustrating one example of cross carrier scheduling 648 in accordance with the systems and methods disclosed herein. The UE described in connection with FIG. 6 may be one example of the UE 302 described in connection with FIG. 3. The eNB described in connection with FIG. 6 may be one example of the eNB 360 described in connection with FIG. 3. The UE may monitor the PDCCH for a RNTI when necessary. The UE may decode the PDSCH based on the downlink assignment by the PDCCH. The PDSCH for a UE may normally be scheduled by a PDCCH whose CRC parity bits are scrambled by a C-RNTI assigned to the UE. The PDCCH for the C-RNTI is transmitted in the common search space or a UE specific search space, which is calculated by the C-RNTI. In the PCell, a PDSCH for a RAR (random access response) is scheduled by a PDCCH whose CRC parity bits are scrambled by a RA-RNTI (random access RNTI). The PDCCH for the RA-RNTI may be transmitted in a common search space.

In order to enable cross carrier scheduling 648, one or more of the following procedures may be applied. In a scheduling cell 688, a carrier indicator field (CIF) may be attached to the PDCCH in the UE specific search space in order to identify which carrier is scheduled by the PDCCH. When cross carrier scheduling 648 is configured, the UE may not need to monitor 690 any PDCCH on a scheduled cell 694. Furthermore, the PDSCH 692 on the scheduled cell 694 may be scheduled by a scheduling cell 688 carrying a PDCCH 684. Scheduling cells 688 may be a PCell and/or one or more SCells. The scheduling cell 688 illustrated in FIG. 6 may be one example of one or more of the scheduling cells described herein. Scheduled cells 694 may be one or more SCells. The scheduled cell 694 illustrated in FIG. 6 may be one example of one or more scheduled cells described herein. It should be noted that a PDSCH 686 on the scheduling cell 688 is illustrated in FIG. 6.

However, there is the common search space only in the PCell and the PDCCH for the RA-RNTI may only be mapped in the common search space because (basically) a RAR may be for any UE in the cell and cannot be cross carrier scheduled. When the UE is configured with a PRACH in an SCell, the UE may be allowed to perform non-contention based random access (e.g., contention free random access) only. In non-contention based random access, a Msg0 is used in order to initiate the random access using a PDCCH (in PDCCH ordered random access, for example). It should be noted that PDCCH ordered random access can initiate not only non-contention based random access but also contention based random access. In that case (e.g., PDCCH ordered random access for an SCell), the eNB can schedule a RAR for (e.g., based on) the PRACH transmission in an SCell in the UE specific search space since the eNB knows which UE is transmitting a RA preamble and the RAR can be dedicatedly scheduled (e.g., scheduled specific to that UE). In contention based random access, the eNB may not know which UE is transmitting, though the eNB can know the timing for PDCCH ordered random access since the preamble transmission is initiated by the Msg0.

Normally, an eNB uses the PDCCH for the C-RNTI to schedule dedicated information to the UE. However, the PDCCH for the C-RNTI is used for normal PDSCH scheduling and a normal HARQ process while the RAR may not need a HARQ process. The HARQ process for a RAR could have a big impact on normal procedures since the UE cannot distinguish the difference between a normal HARQ procedure and a RAR procedure by using a C-RNTI. To overcome these problems, the UE may be assigned a new C-RNTI (which may be referred to as a RAR C-RNTI) by the eNB. By this RAR C-RNTI, the UE may identify the difference between a normal HARQ procedure by the C-RNTI and a RAR procedure by a RAR C-RNTI. This RAR C-RNTI may be allocated by RRC signaling.

In some configurations, a downlink subframe may include a PDCCH region and a PDSCH region. The PDCCH region and the PDSCH region may be separated in time during a subframe. The PDCCH region of a subframe may include a common search space and a UE specific search space. The common search space and the UE specific search space may refer to a set of resource elements (REs) of the PDCCH region. The smallest resource unit is denoted a resource element (RE), which may consist of a subcarrier and a single-carrier frequency-division multiple access (SC-FDMA) or orthogonal frequency-division multiplexing (OFDM) symbol. One or more PDCCHs may be mapped into the PDCCH region and one or more PDSCHs may be mapped into the PDSCH region.

FIG. 7 is a block diagram illustrating one example of radio resource control (RRC) connection reconfiguration signaling. The RAR C-RNTI assignment may be done by a RRC connection reconfiguration procedure that is used to modify an RRC connection (e.g., to establish, modify or release resource blocks (RBs), to perform handover, to setup, modify or release measurements, to add, modify or release SCells, etc.). As illustrated in FIG. 7, the Evolved Universal Terrestrial Radio Access Network (E-UTRAN or EUTRAN) 725 (e.g., eNB) may send an RRCConnectionReconfiguration message 796 to the UE 702. The UE 702 may respond by sending an RRCConnectionReconfigurationComplete message 723 to the EUTRAN 725 (e.g., eNB). The UE 702 illustrated in FIG. 7 may be one example of the UE 302 illustrated in FIG. 3. The EUTRAN 725 illustrated in FIG. 7 may be one example of the eNB 360 illustrated in FIG. 3.

Alternatively, the RAR C-RNTI may be the same value as the RA-RNTI (e.g., the RA-RNTI may be used instead of the RAR C-RNTI). For random access in a PCell (e.g., PCell 319), the RA-RNTI may be monitored by only the common search space. However, in PDCCH ordered RA for the SCell, the eNB may transmit a PDCCH for RA-RNTI to the UE in a UE specific search space and the UE may monitor the PDCCH for RA-RNTI for an SCell in the UE specific search space. The RA-RNTI may be defined corresponding to a PRACH resource and the RA-RNTI may be calculated and generated by the UE according to the PRACH resource in which the preamble is sent by the UE. This may be a similar procedure as a procedure in Release-10, except for the search space. In this case, the RAR C-RNTI assignment may be done without RRC signaling. The benefit of this approach is that the RAR may be shared with other UEs because the RA-RNTI may be shared among UEs.

The RAR C-RNTI or RA-RNTI may be used to schedule a RAR based on a PRACH preamble transmission on an SCell. CRC parity bits of the PDCCH may be scrambled by the RAR C-RNTI or RA-RNTI. The PDCCH with the RAR C-RNTI or RA-RNTI may schedule a PDSCH for RAR and may be transmitted in a UE specific search space that is calculated by the normal C-RNTI. When the UE detects a RAR C-RNTI or RA-RNTI, the UE may perform a RAR reception procedure and the RAR media access control (MAC) control element (CE) may have the same structure as a normal RAR or may be allowed some extension from the structure of the normal RAR. Apart from a normal C-RNTI, the UE may not perform a HARQ process for the RAR. That is, the UE may not send HARQ acknowledgement (ACK) or HARQ negative acknowledgement (NACK) to the eNB after decoding the RAR.

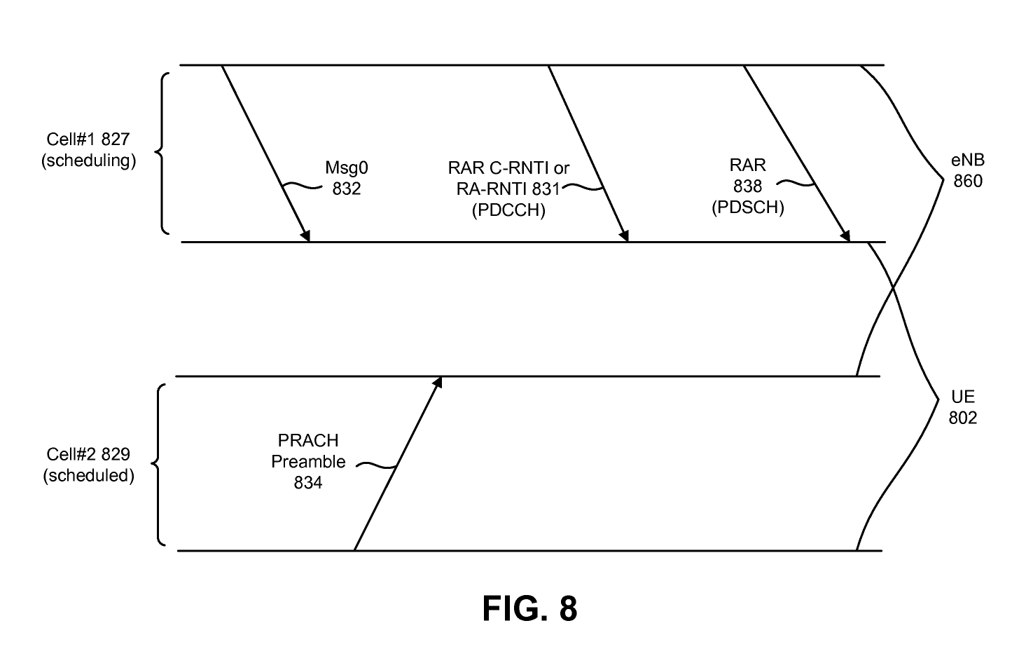

FIG. 8 is a diagram illustrating one example of a physical downlink control channel (PDCCH) for a random access response (RAR) cell radio network temporary identifier (C-RNTI) or a RA-RNTI 831 and a physical downlink shared channel (PDSCH) for RAR 838 in a scheduling cell 827. The PDSCH for the RAR 838 may be scheduled in a scheduling cell 827 (e.g., Cell#1) as illustrated in FIG. 8. For example, a UE 802 may receive a Msg0 832 from an eNB 860 on a scheduling cell 827. The UE 802 may generate and send a physical random access channel (PRACH) preamble 834 to the eNB 860 on a scheduled cell 829 (e.g., Cell#2). The eNB 860 may then send a RAR C-RNTI or a RA-RNTI 831 in a PDCCH on the scheduling cell 827. The eNB 860 may also send a RAR 838 in a PDSCH on the scheduling cell 827.

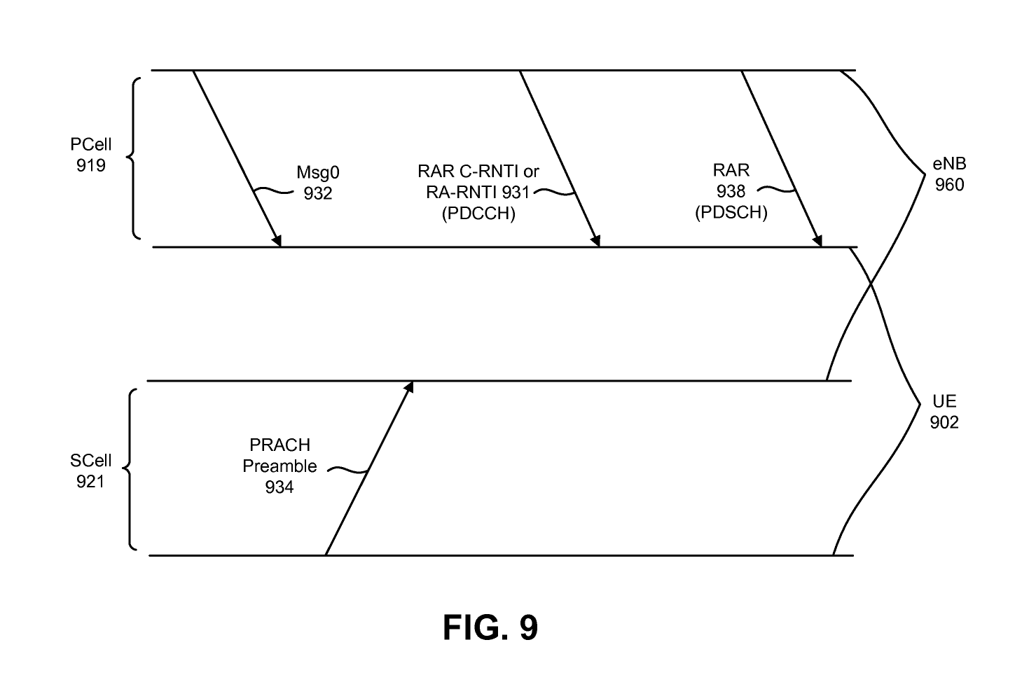

FIG. 9 is a diagram illustrating an example of a physical downlink control channel (PDCCH) for a random access response (RAR) cell radio network temporary identifier (C-RNTI) or a RA-RNTI 931 and a physical downlink shared channel (PDSCH) for RAR 938 in a primary cell (PCell) 919. In this example, the PDSCH for the RAR 938 may be scheduled in only the PCell 919 as illustrated in FIG. 9. For example, a UE 902 may receive a Msg0 932 from an eNB 960 on a PCell 919. The UE 902 may generate and send a physical random access channel (PRACH) preamble 934 to the eNB 960 on an SCell 921. The eNB 960 may then send a RAR C-RNTI or a RA-RNTI 931 in a PDCCH on the PCell 919. The eNB 960 may also send a RAR 938 in a PDSCH on the PCell 919.

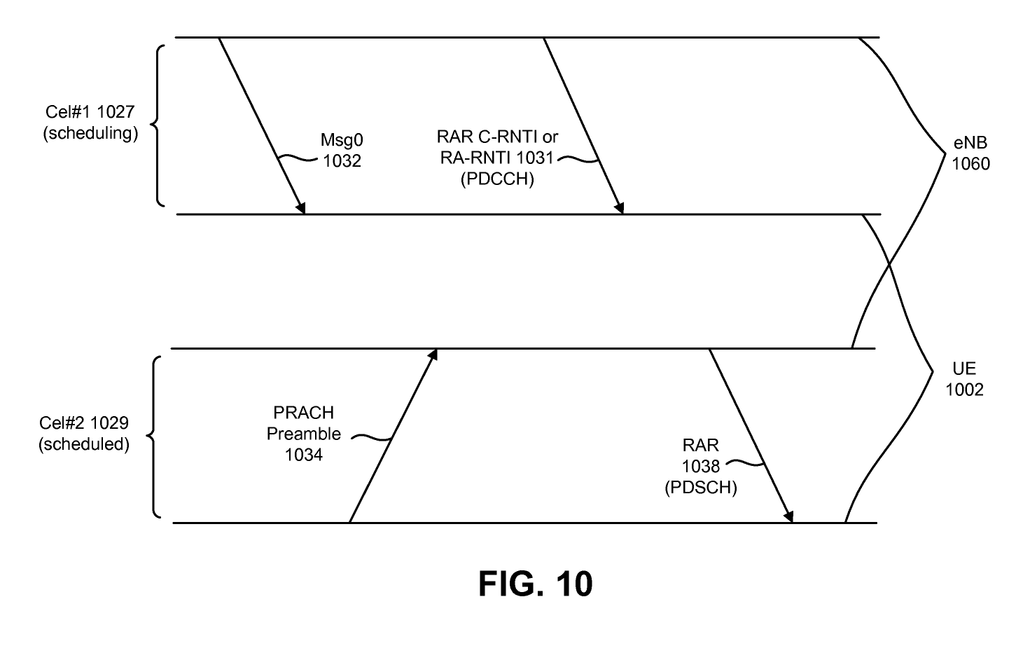

FIG. 10 is a diagram illustrating an example of a physical downlink control channel (PDCCH) for a random access response (RAR) cell radio network temporary identifier (C-RNTI) or a RA-RNTI 1031 in a scheduling cell 1027 and a physical downlink shared channel (PDSCH) for a RAR 1038 in a scheduled cell 1029. In this example, the PDSCH for the RAR 1038 may be scheduled in a scheduled cell 1029 as illustrated in FIG. 10. For example, a UE 1002 may receive a Msg0 1032 from an eNB 1060 on a scheduling cell (e.g., Cell#1) 1027. The UE 1002 may generate and send a physical random access channel (PRACH) preamble 1034 to the eNB 1060 on a scheduled cell (e.g., Cell#2) 1029. The eNB 1060 may then send a RAR C-RNTI or a RA-RNTI 1031 in a PDCCH on the scheduling cell 1027. The eNB 1060 may send a RAR 1038 in a PDSCH on the scheduled cell (e.g., Cell#2) 1029.

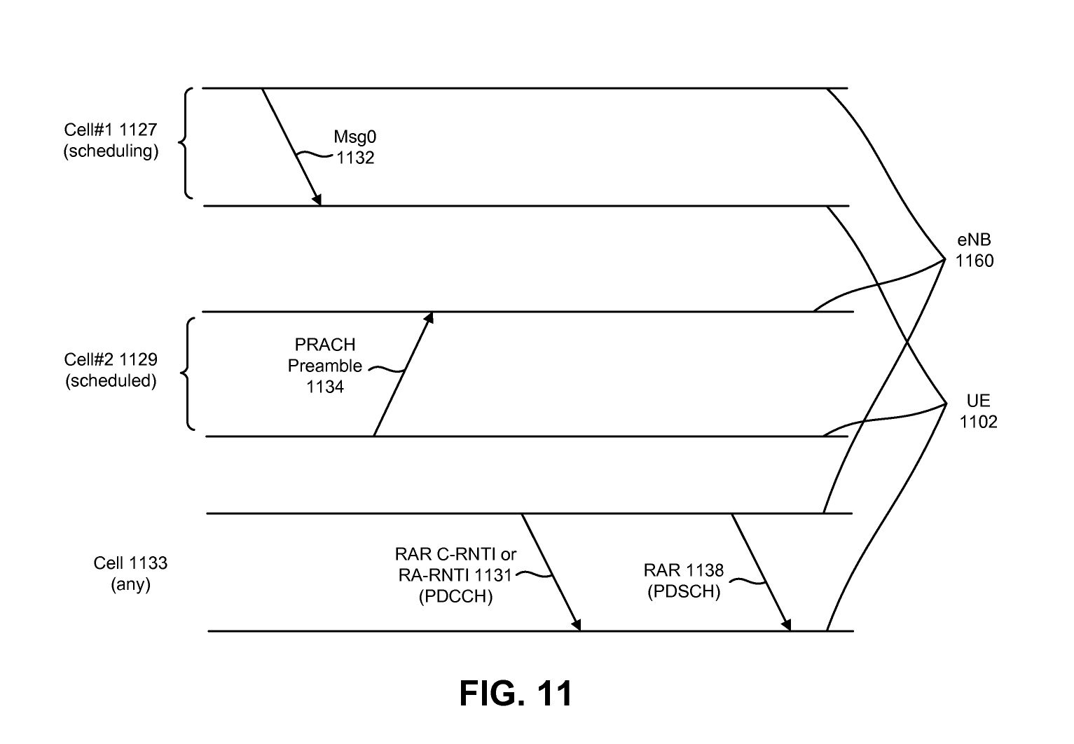

FIG. 11 is a diagram illustrating an example of a physical downlink control channel (PDCCH) for a random access response (RAR) cell radio network temporary identifier (C-RNTI) or a RA-RNTI 1131 and a physical downlink shared channel (PDSCH) for a RAR 1138 in any cell 1133. For example, the PDSCH for the RAR 1138 may be scheduled in any cell 1133 that is indicated by the PDCCH as illustrated in FIG. 11. For example, a UE 1102 may receive a Msg0 1132 from an eNB 1160 on a scheduling cell (e.g., Cell#1) 1127. The UE 1102 may generate and send a physical random access channel (PRACH) preamble 1134 to the eNB 1160 on a scheduled cell (e.g., Cell#2) 1129. The eNB 1160 may then send a RAR C-RNTI or a RA-RNTI 1131 in a PDCCH on any cell 1133 (which may include the scheduling cell 1127 and the scheduled cell 1129, for instance). The eNB 1160 may send a RAR 1138 in a PDSCH on any cell 1133.

The RAR C-RNTI may be per UE or per cell. If the RAR C-RNTI is per cell when the UE is configured with a PRACH for an SCell, the RAR C-RNTI for each SCell having the PRACH may be allocated to the UE. By doing this, the UE may identify which PRACH transmission the RAR is for. If the RAR C-RNTI is per UE when the UE is configured with PRACHs for any SCells, only one RAR C-RNTI for the UE may be allocated to the UE. By doing this, the UE can reduce the complexity of monitoring the RAR C-RNTI. In the case that the RA-RNTI is used for a random access for an SCell, the RA-RNTI is per cell. Each cell may use the same value for the RA-RNTI, but this may not cause a problem since the UE can have only one random access procedure and a carrier indicator may be transmitted together with the RA-RNTI.

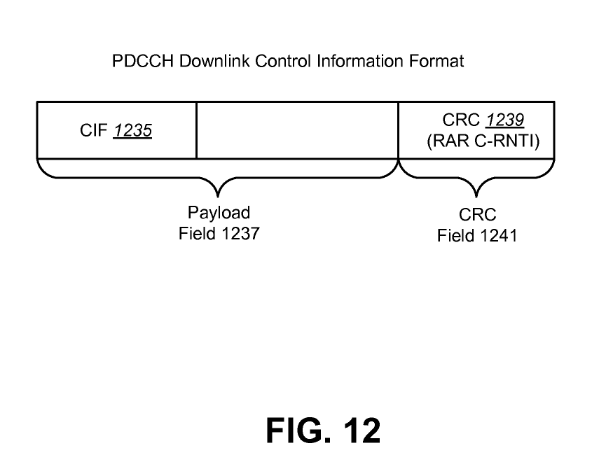

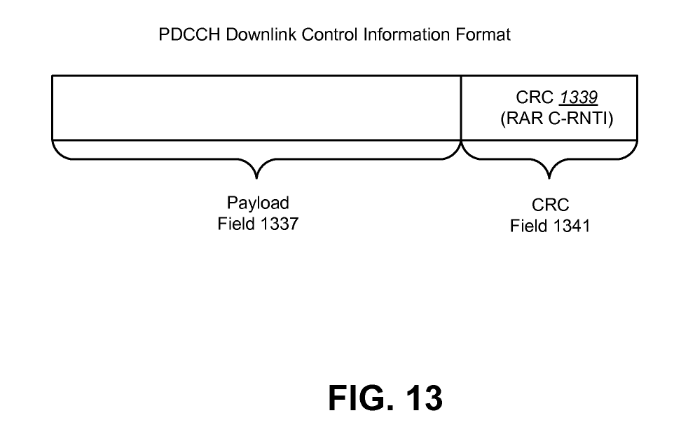

FIG. 12 is a diagram illustrating one example of a physical downlink control channel (PDCCH) downlink control information format for a random access response (RAR) cell radio network temporary identifier (C-RNTI) with a carrier indicator field (CIF) 1235. As illustrated in FIG. 12, a payload field 1237 may include a CIF 1235 in some configurations. The carrier indicator field (CIF) 1235 may carry a carrier indicator, which may be a serving cell index for a cell scheduled for a PDSCH. PDCCH downlink control information (DCI) for RAR C-RNTI and/or RA-RNTI may or may not include the CIF 1235 as illustrated in FIG. 12 (and FIG. 13). A UE (e.g., UE 302) monitors DCI Format 1A with a cyclic redundancy check (CRC) code 1239 in a CRC field 1241 scrambled by the RAR C-RNTI or RA-RNTI in a UE specific search space. It should be noted that in FIGS. 12-14, the RAR C-RNTI may instead be RA-RNTI in some configurations. By doing this, the UE can monitor the RAR C-RNTI or RA-RNTI without increasing the amount of blind decoding, since the UE needs to monitor DCI Format 1A in a UE specific search space anyway. It should be noted that the downlink control information (e.g., CIF 1235, CRC 1239) described in connection with FIG. 12 may be sent by an eNB (e.g., eNB 360) and received by a UE (e.g., UE 102).

FIG. 13 is a diagram illustrating an example of a physical downlink control channel (PDCCH) downlink control information format for a random access response (RAR) cell radio network temporary identifier (C-RNTI) without a carrier indicator field (CIF). As illustrated in FIG. 13, a payload field 1337 may not include a CIF in some configurations. The PDCCH downlink control information format illustrated in FIG. 13 may also include a CRC field 1341. The CRC field 1341 may include a CRC code 1339 scrambled by a RAR C-RNTI (or RA-RNTI). As illustrated in FIG. 12 and FIG. 13, PDCCH downlink control information for RAR C-RNTI may or may not include a CIF. It should be noted that the downlink control information (e.g., CRC 1339) described in connection with FIG. 13 may be sent by an eNB (e.g., eNB 360) and received by a UE (e.g., UE 102).

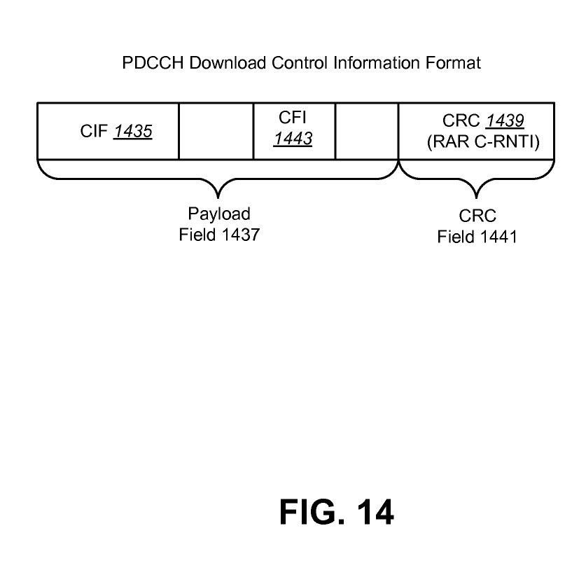

FIG. 14 is a diagram illustrating an example of a physical downlink control channel (PDCCH) downlink control information format for a random access response (RAR) cell radio network temporary identifier (C-RNTI) with a carrier indicator field (CIF) 1435 and a control format indicator (CFI) 1443. The PDCCH downlink control information format illustrated in FIG. 14 may also include a CRC field 1441. The CRC field 1441 may include a CRC code 1439 scrambled by a RAR C-RNTI (or RA-RNTI). It should be noted that the downlink control information (e.g., CIF 1435, CFI 1443, CRC 1439) described in connection with FIG. 14 may be sent by an eNB (e.g., eNB 360) and received by a UE (e.g., UE 102).

In order to perform a cross carrier scheduled RAR and share the same resource block with RAR in a scheduled cell, it may be necessary for the UE (e.g., UE 302) to know the orthogonal frequency-division multiplexing (OFDM) symbol for starting a PDSCH. In non-cross carrier scheduling, a Physical Control Format Indicator Channel (PCFICH) may be used to inform a UE (e.g., UE 302) of a Control Format Indicator (CFI), which includes information about the number of OFDM symbols used for transmission of PDCCHs in a subframe (e.g., the OFDM symbol for starting a PDSCH). However, for cross carrier scheduling, it may be difficult for the UE (e.g., UE 302) to obtain (e.g., receive) a PCFICH for a scheduled cell. Therefore, PDCCH DCI Format 1A for the RAR C-RNTI and/or RA-RNTI for cross carrier scheduling may carry a CFI of a scheduled cell. For instance, when the UE (e.g., UE 302) is configured with the carrier indicator field (CIF) for a given serving cell, PDCCH DCI Format 1A for the RAR C-RNTI and/or RA-RNTI on the serving cell may carry a Control Format Indicator (CFI) of the cell indicated by the Carrier Indicator Field (CIF).

PDCCH downlink control information for RAR C-RNTI and/or RA-RNTI may include a CIF 1435 and a CFI 1443 as illustrated in FIG. 14. For example, a payload field 1437 may include the CIF 1435 and CFI 1443. Because a transmit power control (TPC) command field and a hybrid automatic repeat request (HARQ) process number field have not been used in Release-10, the CFI 1443 may be mapped to either a TPC command field or a HARQ process number field.

Some benefits of the systems and methods disclosed herein are given hereafter. The eNB (e.g., eNB 360) and the UE (e.g., UE 302) may operate well in the scenario that needs to have a RACH in a SCell. Furthermore, the eNB may allocate resources to a UE for multiple carriers with different physical timing. Additionally, the systems and methods disclosed herein may reduce operational cost or implementation cost to manage multiple RACHs.

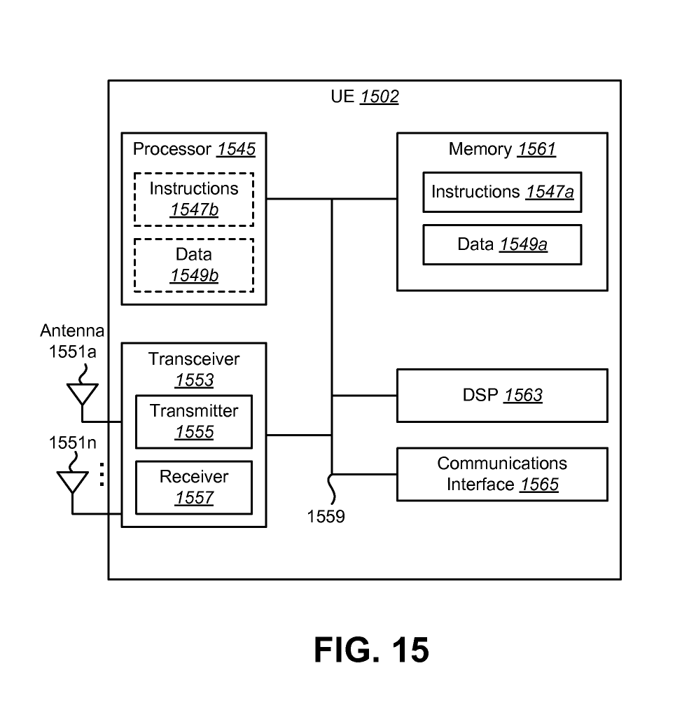

FIG. 15 illustrates various components that may be utilized in a user equipment (UE) 1502. The UE 1502 may be utilized as one or more of the UEs 302, 702, 802, 902, 1002, 1102 described above. The UE 1502 includes a processor 1545 that controls operation of the UE 1502. The processor 1545 may also be referred to as a central processing unit (CPU). Memory 1561, which may include read-only memory (ROM), random access memory (RAM), a combination of the two or any type of device that may store information, provides instructions 1547a and data 1549a to the processor 1545. A portion of the memory 1561 may also include non-volatile random access memory (NVRAM). Instructions 1547b and data 1549b may also reside in the processor 1545. Instructions 1547b and/or data 1549b loaded into the processor 1545 may also include instructions 1547a and/or data 1549a from memory 1561 that were loaded for execution or processing by the processor 1545. The instructions 1547b may be executed by the processor 1545 to implement one or more of the methods 500 disclosed herein.

The UE 1502 may also include a housing that contains one or more transmitters 1555 and one or more receivers 1557 to allow transmission and reception of data. The transmitter(s) 1555 and receiver(s) 1557 may be combined into one or more transceivers 1553. One or more antennas 1551a-n are attached to the housing and electrically coupled to the transceiver 1553.

The various components of the UE 1502 are coupled together by a bus system 1559, which may include a power bus, a control signal bus and a status signal bus, in addition to a data bus. However, for the sake of clarity, the various buses are illustrated in FIG. 15 as the bus system 1559. The UE 1502 may also include a digital signal processor (DSP) 1563 for use in processing signals. The UE 1502 may also include a communications interface 1565 that provides user access to the functions of the UE 1502. For example, the communications interface 1565 may include one or more input devices (e.g., touch screens, ports, microphones, etc.) and/or one or more output devices (e.g., displays, speakers, printers, ports, etc.). The UE 1502 illustrated in FIG. 15 is a functional block diagram rather than a listing of specific components.

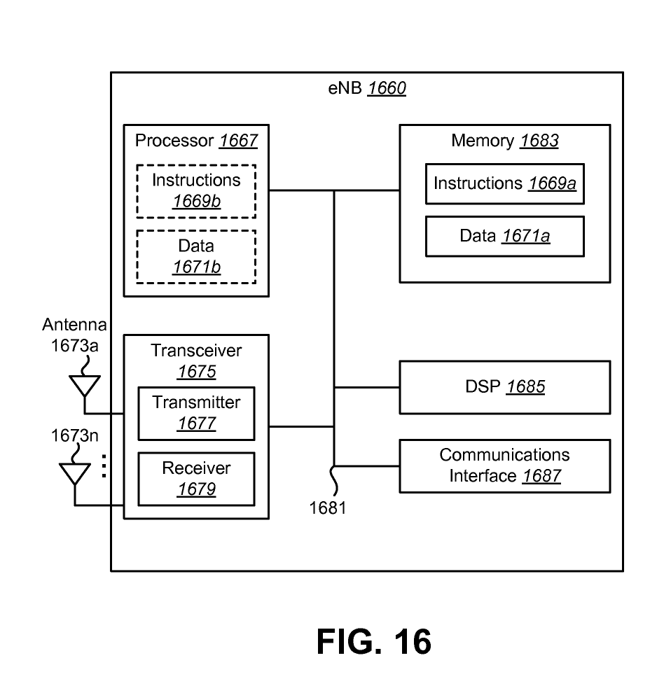

FIG. 16 illustrates various components that may be utilized in an evolved Node B (eNB) 1660. The eNB 1660 may be utilized as one or more of the eNBs 360, 860, 960, 1060, 1160 described previously. The eNB 1660 may include components that are similar to the components discussed above in relation to the UE 1502, including a processor 1667, memory 1683 that provides instructions 1669a and data 1671a to the processor 1667, instructions 1669b and data 1671b that may reside in or be loaded into the processor 1667, a housing that contains one or more transmitters 1677 and one or more receivers 1679 (which may be combined into one or more transceivers 1675), one or more antennas 1673a-n electrically coupled to the transceiver(s) 1675, a bus system 1681, a DSP 1685 for use in processing signals, a communications interface 1687 and so forth. The instructions 1669b may be executed by the processor 1667 to implement one or more of the methods 400 disclosed herein.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. An evolved Node B (eNB) configured for random access response scheduling, comprising:
a processor;
memory in electronic communication with the processor;
instructions stored in the memory, the instructions being executable to:
send a message to initiate a random access procedure for a secondary cell (SCell);
receive a physical random access channel (PRACH) preamble;
send a radio network temporary identifier (RNTI) for a random access response (RAR) in a physical downlink control channel (PDCCH) in a user equipment (UE) specific search space; and
send the RAR in a physical downlink shared channel (PDSCH).

2. The eNB of claim 1, wherein a cell in which the PRACH preamble is received is different from a cell in which the RNTI for the RAR is sent.

3. The eNB of claim 1, wherein cyclic redundancy check (CRC) parity bits of the PDCCH are scrambled by the RNTI.

4. The eNB of claim 1, wherein the UE specific search space is calculated based on a cell radio network temporary identifier (C-RNTI).

5. The eNB of claim 1, wherein downlink control information (DCI) for the PDCCH with the RNTI for the RAR includes a carrier indicator.

6. The eNB of claim 5, wherein the DCI for the PDCCH with the RNTI for the RAR includes a control format indicator.

7. The eNB of claim 1, wherein the PDCCH with the RNTI for the RAR uses a DCI Format 1A.

8. A method for random access response scheduling on an evolved Node B (eNB), comprising:
sending a message to initiate a random access procedure for a secondary cell (SCell);
receiving a physical random access channel (PRACH) preamble;
sending a radio network temporary identifier (RNTI) for a random access response (RAR) in a physical downlink control channel (PDCCH) in a user equipment (UE) specific search space; and
sending the RAR in a physical downlink shared channel (PDSCH).

9. The method of claim 8, wherein a cell in which the PRACH preamble is received is different from a cell in which the RNTI for the RAR is sent.

10. The method of claim 8, wherein cyclic redundancy check (CRC) parity bits of the PDCCH are scrambled by the RNTI.

11. The method of claim 8, wherein the UE specific search space is calculated based on a cell radio network temporary identifier (C-RNTI).

12. The method of claim 8, wherein downlink control information (DCI) for the PDCCH with the RNTI for the RAR includes a carrier indicator.

13. The method of claim 12, wherein the DCI for the PDCCH with the RNTI for the RAR includes a control format indicator.

14. The method of claim 8, wherein the PDCCH with the RNTI for the RAR uses a DCI Format 1A.

15. A User Equipment (UE) configured for random access response scheduling, comprising:
a processor;
memory in electronic communication with the processor;
instructions stored in the memory, the instructions being executable to:
receive a message to initiate a random access procedure for a secondary cell (SCell);
send a physical random access channel (PRACH) preamble;
receive a radio network temporary identifier (RNTI) for a random access response (RAR) in a physical downlink control channel (PDCCH) in a user equipment (UE) specific search space; and
receive the RAR in a physical downlink shared channel (PDSCH).

16. The UE of claim 15, wherein a cell in which the PRACH preamble is sent is different from a cell in which the RNTI for the RAR is received.

17. The UE of claim 15, wherein cyclic redundancy check (CRC) parity bits of the PDCCH are scrambled by the RNTI.

18. The UE of claim 15, wherein the UE specific search space is calculated based on a cell radio network temporary identifier (C-RNTI).

19. The UE of claim 15, wherein the UE does not perform a hybrid automatic repeat request (HARQ) process for the RAR.

20. The UE of claim 15, wherein downlink control information (DCI) for the PDCCH with the RNTI for the RAR includes a carrier indicator.

21. The UE of claim 20, wherein the DCI for the PDCCH with the RNTI for the RAR includes a control format indicator.

22. The UE of claim 15, wherein the PDCCH with the RNTI for the RAR uses a DCI Format 1A.

23. A method for random access response scheduling on a user equipment (UE), comprising:
receiving a message to initiate a random access procedure for a secondary cell (SCell);
sending a physical random access channel (PRACH) preamble;
receiving a radio network temporary identifier (RNTI) for a random access response (RAR) in a physical downlink control channel (PDCCH) in a user equipment (UE) specific search space; and
receiving the RAR in a physical downlink shared channel (PDSCH).

24. The method of claim 23, wherein a cell in which the PRACH preamble is sent is different from a cell in which the RNTI for the random access response is received.

25. The method of claim 23, wherein cyclic redundancy check (CRC) parity bits of the PDCCH are scrambled by the RNTI.

26. The method of claim 23, wherein the UE specific search space is calculated based on a cell radio network temporary identifier (C-RNTI).

27. The method of claim 23, wherein the UE does not perform a hybrid automatic repeat request (HARQ) process for the RAR.

28. The method of claim 23, wherein downlink control information (DCI) for the PDCCH with the RNTI for the RAR includes a carrier indicator.

29. The method of claim 28, wherein the DCI for the PDCCH with the RNTI for the RAR includes a control format indicator.

30. The method of claim 23, wherein the PDCCH with the RNTI for the RAR uses a DCI Format 1A.
